(19) United States
(12) Patent Application Publication
(10) Pub. No.: US 2026/0228602 A1
(43) Pub. Date: Aug. 6, 2026

(54) INTELLIGENT RUPTURE EXPOSURE RADIUS CALCULATOR

(71) Applicant: SAUDI ARABIAN OIL COMPANY, Dhahran (SA)

(72) Inventors: Ammal F. Al-Anazi, Dammam (SA); Muhammad Daanyal, Ras Tanura (SA)

(73) Assignee: SAUDI ARABIAN OIL COMPANY, Dhahran (SA)

(21) Appl. No.: 19/042,526

(22) Filed: Jan. 31, 2025

(51) Int. Cl. G06N 20/00

(52) U.S. Cl. CPC G06N 20/00

(57) ABSTRACT

A method for computing and using a rupture exposure radius. The method includes obtaining process data for a production facility configured to convey a production fluid that includes one or more hazardous materials and obtaining, for each hazardous material among the one or more hazardous materials, one or more safety limits associated with each hazardous material. The method further includes determining, using an artificial intelligence model based on the process data, one or more predicted rupture exposure radii including a predicted rupture exposure radius for each hazardous material and associated one or more safety limits. The method further includes determining a safety protocol for the production facility based on the one or more predicted rupture exposure radii and performing a facility operation associated with the production facility in accordance with the safety protocol.

### BACKGROUND

In the oil and gas industry, production fluids are transported in diverse facilities, such as a production well, a pipeline and/or a processing plant, where any of these may be considered, or contain, conveying equipment. Production fluids may contain hazardous substances, such as flammable hydrocarbons and hydrogen sulfide that, in case of a rupture of conveying equipment, may escape and pose a risk for surrounding populations and environment. For instance, flammable hydrocarbons may present a fire hazard and hydrogen sulfide may present a chemical hazard due to its toxic effects. For this reason, oil and gas facilities are generally designed and maintained in accordance with safety protocols that may help mitigate or prevent these risks.

In case of a rupture of the conveying equipment, the concentration of a hazardous substance is usually very high near the rupture location and decreases progressively as it propagates away from the rupture location. In turn, the risk may be reduced based on a distance from the rupture location. Therefore, it may be advantageous to know at which distance from the rupture, known as a rupture exposure radius, the concentration of a hazardous substance is at a pre-determined safety limit for populations.

Physical models exist for predicting rupture exposure radii. However, these models are generally inaccurate and rely on generic, theoretical data. Accordingly, there exists a need for an accurate method for computing a rupture exposure radius based on real, field data.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for computing and using a rupture exposure radius. The method includes obtaining process data for a production facility configured to convey a production fluid that includes one or more hazardous materials and obtaining, for each hazardous material among the one or more hazardous materials, one or more safety limits associated with each hazardous material. The method further includes determining, using an artificial intelligence model based on the process data, one or more predicted rupture exposure radii including a predicted rupture exposure radius for each hazardous material and associated one or more safety limits. The method further includes determining a safety protocol for the production facility based on the one or more predicted rupture exposure radii and performing a facility operation associated with the production facility in accordance with the safety protocol.

In one aspect, embodiments disclosed herein relate to a system for computing and using a rupture exposure radius. The system includes a computer including one or more computer processors configured to receive process data for a production facility configured to convey a production fluid that include one or more hazardous materials. The computer is further configured to receive, for each hazardous material among the one or more hazardous materials, one or more safety limits associated with each hazardous material. The computer is further configured to determine, using an artificial intelligence model based on the process data, one or more predicted rupture exposure radii including a predicted rupture exposure radius for each hazardous material and associated one or more safety limits. The system further includes a safety planning system configured to determine a safety protocol for the production facility based on the one or more predicted rupture exposure radii and a service system configured to perform a facility operation associated with the production facility in accordance with the safety protocol.

In one aspect, embodiments disclosed herein relate to a non-transitory computer-readable memory for computing and using a rupture exposure radius. The non-transitory computer-readable memory includes computer-executable instructions stored thereon that, when executed on a processor, cause the processor to perform steps including obtaining process data for a production facility configured to convey a production fluid that includes one or more hazardous materials. The steps further include obtaining, for each hazardous material among the one or more hazardous materials, one or more safety limits associated with each hazardous material. The steps further include determining, using an artificial intelligence model based on the process data, one or more predicted rupture exposure radii including, a predicted rupture exposure radius for each hazardous material and associated one or more safety limits. The steps further include sending a command for a safety planning system to determine a safety protocol for the production facility based on the one or more predicted rupture exposure radii and sending a command for a service system to perform a facility operation associated with the production facility in accordance with the safety protocol.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a production well in accordance with one or more embodiments disclosed herein.

FIG. 2 depicts a block diagram of a system for predicting rupture exposure radii in accordance with one or more embodiments disclosed herein.

FIG. 3 depicts a block diagram of an artificial intelligence model in accordance with one or more embodiments disclosed herein.

FIG. 4 depicts a block diagram of a safety system in accordance with one or more embodiments disclosed herein.

FIG. 5 depicts a flow chart of a method for determining one or more rupture exposure radii and performing a facility operation in accordance with one or more embodiments disclosed herein.

FIG. 6 depicts an example diagram of a neural network, in accordance with one or more embodiments disclosed herein.

FIG. 7 depicts an example diagram of a computer, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

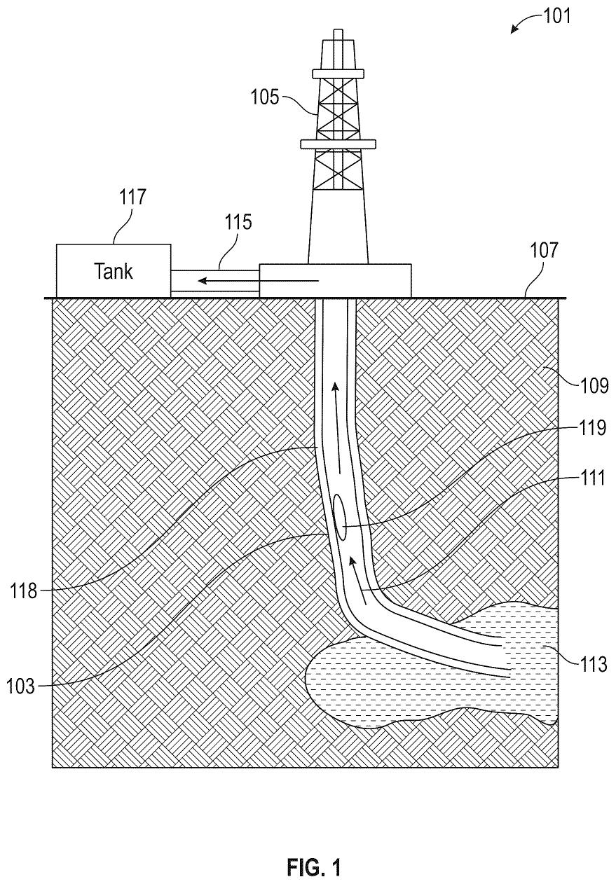

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems are disclosed for predicting rupture exposure radii (RER) for a production fluid using artificial intelligence. Methods and systems disclosed further include determining, based on the predicted rupture exposure radii, a safety protocol for a production facility that conveys the production fluid. “Production facility,” as used herein, can include or relate to one or more of a production well, a pipeline, a processing plant, or other conveying equipment used to transport a fluid. Advantageously, the methods and system disclosed are automated and may be run in real-time. Advantageously, the methods and system disclosed may receive real data acquired by in-situ sensors. The method and system disclosed include determining a safety protocol for a production facility to be built at a new location, an existing production facility in operation, or a production facility to be re-activated after being abandoned.

In the hydrocarbon production industry, production fluids containing hydrocarbons are conveyed in various production facilities. As a first example of a production facility, a production well may convey a production fluid from a hydrocarbon reservoir to the surface, through a wellbore. As a second example, a pipeline may convey a production fluid from one geographical location to another geographical location. As a third example of a production facility, a production facility such as a gas processing plant, may transform and convey a production fluid from one processing unit to another processing unit. The production fluid may be conveyed using conveying equipment, such as a wellbore or a pipe.

FIG. 1 depicts a production well (101) configured to produce hydrocarbons. A production well may be configured in a myriad of ways. Therefore, the production well (101) is not intended to be limiting to any particular configuration. The production well (101) is depicted as being on land. In other examples, the production well (101) may be located offshore. In FIG. 1, a production fluid is extracted from a hydrocarbon reservoir (113) located in a subsurface (109). The production fluid is conveyed from the hydrocarbon reservoir (113) to a surface (107) through a wellbore (103) in a direction (111). In some instances, the production fluid is extracted using a derrick (105) located on the surface (107). A pipeline (115) further conveys the production fluid from the derrick (105) to a tank (117), in which the production fluid is collected. A casing (118), disposed in the production well (101) against the wellbore (103), may be formed of a durable material such as steel. The casing (118) isolates the hydrocarbons and supports the wellbore (103).

In one or more embodiments, one or more sensors (119), installed on the production well (101), are set up to acquire process data at one or more locations in the wellbore (103). Additional sensors (not shown) can be installed at one or more locations at, or above, the surface (107). Examples of process data that may be acquired by the sensors include a production fluid production rate, a density of the production fluid, a velocity of the production fluid through the wellbore (103), a concentration of a material within the production fluid, a pressure and a temperature at the one or more sensors' (119) locations. Examples of sensors that may be included in the one or more sensors include a pressure sensor, a flow rate sensor, a temperature sensor, a gas detector, and a multiphase flow meter. In FIG. 1, the one or more sensors (119) are grouped together and located downhole on the side of the wellbore (103). However, this example should not be considered limiting and in other embodiments the one or more sensors (119) may be separated and located anywhere, downhole or at the surface, connected to the wellbore (103).

Generally, the production fluid contains various materials, such as, for example, hydrocarbons, water and gases. More specifically, the production fluid contains one or more hazardous materials. Examples of hazardous materials that may be contained in the production fluid include a flammable hydrocarbon that presents a fire hazard, such as petroleum, methane, ethane and natural gas liquids. Examples of hazardous materials that may be contained in the production fluid further include a toxic gas that presents a chemical hazard, such as hydrogen sulfide (H₂S). Exposure to H₂S may cause various health effects, ranging from irritation of the eyes, nose, and throat to more severe respiratory issues or death. Examples of hazardous materials that may be contained in the production fluid and present a chemical hazard further include benzene. Exposure to benzene may also cause various health effects, such as leukemia. Some hazardous materials may present multiple hazards. For instance, H₂S is flammable and thus presents a flammable hazard in addition to a chemical hazard. The hazardous materials described herein are given only as examples and should not be considered limiting. One with ordinary skill in the art will readily appreciate that the production fluid may contain fewer or additional hazardous materials from the above-described hazardous materials without departing from the scope of this disclosure.

In case of a rupture of the conveying equipment, the production fluid is released. The one or more hazardous materials may propagate away from the rupture location, thereby posing a risk for neighboring populations, the neighboring environment, and nearby structures (e.g., those located outside the production facility). In some embodiments, the risk posed by a hazardous material at a specific location depends on a concentration of the hazardous material at the specific location. The concentration may be defined in many ways, such as, for example, an airborne volumetric concentration, an airborne mass concentration, an airborne molecular concentration, and a mass concentration in water. In some embodiments, the level of damage upon exposure of a hazardous material and thus is evaluated for some key toxicity concentration levels. For instance, exposure to H₂S at an airborne molecular concentration above 5 parts per million (ppm) may cause nausea, tearing of the eyes and headaches. Exposure to H₂S at an airborne molecular concentration above 0 ppm may cause fatigue, memory issues and dizziness. Exposure to H₂S at an airborne molecular concentration above 50 ppm during at least one hour may cause conjunctivitis and respiratory tract irritation. Exposure to H₂S at an airborne molecular concentration above 100 ppm during at least 48 hours may cause death. Exposure to H₂S at an airborne molecular concentration above 500 ppm during at least 1 hour may cause death. Additionally, exposure to H₂S at an airborne molecular concentration above 1000 ppm may cause substantially immediate loss of consciousness and death within 15 minutes.

An environmental condition may be defined as a set of values defining local properties of air, such as an air pressure, an air temperature and an air humidity. In some embodiments, a hazardous material with an airborne concentration below a certain floor concentration level does not pose a risk. For instance, in some environmental conditions, a flammable material may not be ignited with a concentration lower than an airborne volumetric concentration known as a lower flammable limit (LFL). In some environmental conditions that may commonly be found on the surface of the Earth, the LFL of methane is an airborne volume concentration of 5%. In some environmental conditions that may commonly be found on the surface of the Earth, the LFL of ethane is an airborne volume concentration of 3%. In some environmental conditions that may commonly be found on the surface of the Earth, the LFL of H₂S is an airborne volume concentration of 4.3%.

As the one or more hazardous materials propagate away from the rupture location after a rupture of the conveying equipment, their concentrations may decrease according to a distance from the rupture location (e.g., radial distance). Generally, the airborne concentrations of the one or more hazardous materials are highest at a rupture location at the production facility and decrease as the one or more hazardous materials propagate away from the rupture location. In some environmental conditions, the concentration of a hazardous material decreases with a radial distance from the rupture location. In other words, a first concentration of a hazardous material at a first distance from the rupture location is smaller than a second concentration of the hazardous material at a second distance from the rupture location if the first distance is larger than the second distance. In some environmental conditions, the concentration of a hazardous material at a distance from the rupture location is proportional to the concentration of the hazardous material at the rupture location divided by the square of the distance.

A maximum distance from the rupture location at which a hazardous material may have a certain concentration is known as a rupture exposure radius (RER) associated with the hazardous material and the concentration. The RER associated with a hazardous material and a concentration may be predicted. In embodiments disclosed herein, rupture exposure radii (RERi), where “RERi” is intended to represent the plural of “RER,” associated with the one or more hazardous materials and one or more concentration levels are predicted using artificial intelligence (AI). The RERi associated with the one or more hazardous materials and the one or more concentration levels are called the RERi for the production fluid.

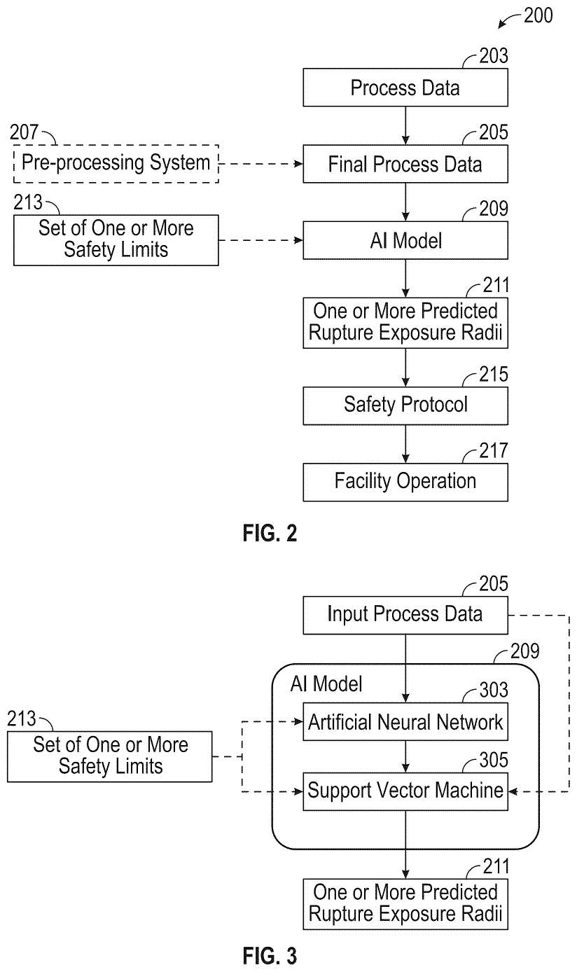

FIG. 2 depicts a system (200) for predicting one or more RERi for a production fluid, thereby defining one or more predicted RERi. The system (200) is further configured to determine and implement a safety protocol based on the one or more predicted RERi. The production fluid includes one or more hazardous materials. The one or more predicted RERi are associated with corresponding hazardous material(s) and specific concentration levels, known as safety limits. In other words, each predicted RER among the predicted RERi is a prediction of the RER associated with a hazardous material and a specific concentration level, known as a safety limit for the hazardous material. In the system (200), process data (203) are obtained for a production facility. The production facility is configured to convey a production fluid, among other uses. The production facility may be a pipeline, a processing plant, or a production well, such as the production well (101) in FIG. 1. The process data (203) may include numerical components and categorical components. The process data (203) may be obtained in many ways. In one or more embodiments, the production facility is an extant production facility in operation. In such embodiments, the process data (203) may be acquired by one or more sensors installed on the production facility, such as the one or more sensors (119) in FIG. 1. In such embodiments, the process data (203) may be referred to as measured process data. The measured process data may include measured numerical components such as, for example, a measured production fluid flow rate (or Absolute Open Flow (AOF)) in the production facility and a measured concentration of a hazardous material in the production fluid, such as a measured molecular concentration of H₂S (mole fraction of hydrogen sulfide (H₂S) in the oil). The measured numerical components may further include a measured ratio between two materials in the production fluid, such as a measured oil-to-gas ratio. The measured process data may further include measured categorical components such as, for example, a measured number of phases included in the production fluid, among a water phase, an oil phase and a gaseous phase.

In one or more embodiments, the production facility is a planned production facility to be constructed. In such embodiments, the process data (203) may be referred to as projected process data. The projected process data may include projected numerical components such as, for example, a projected maximum production fluid flow rate in the production facility and a projected concentration of a material in the production fluid, such as a projected molecular concentration of H₂S. The projected numerical components may further include a projected ratio between two materials or phases in the production fluid, such as a projected oil-to-gas ratio. The projected process data may further include projected categorical components such as, for example, a projected number of phases included in the production fluid, among a water phase, an oil phase and a gaseous phase. The projected process data may be obtained in many ways. In some embodiments, the planned production facility is a planned production well and the projected process data are obtained by performing a geological study of a construction location where the planned production well may be constructed. The geological study may include, for example, an analysis of a subsurface below the construction location, The analysis of the subsurface may include, for example, a stratigraphic analysis of the subsurface, an observation of a seismic image of the subsurface and an extraction of a geophysical attribute from the seismic image, such as a coherency. The geological study may further include an analysis of existing production fluids extracted from existing production wells located in a vicinity of the construction location. The geological study may further include a well log analysis of the existing production wells.

In other embodiments, the planned production facility is a planned pipeline conveying the production fluid from a first location to a second location. In such embodiments, the projected process data may be obtained, for example, by analyzing properties of the production fluid at the first location and analyzing a requirement for the production fluid at the second location. In some implementations, some components of the projected process data, such as a projected maximum production fluid flow rate through the planned pipeline, may be selected or adjusted arbitrarily.

In other implementations, the planned production facility is a planned gas processing plant and the projected process data are imposed by a configuration of the planned gas processing plant. For instance, in some implementations, the projected process data includes a concentration of H₂S in the production fluid. Assuming that compositions of gases to be input to the planned gas processing plant are known, the concentration of H₂S exiting a sweetening unit may be computed according to the specifications of the sweetening unit and the compositions of the gas input to the sweetening unit. As another example, in some implementations, the projected process data includes a projected average pressure of the gases in the planned gas processing plant. The projected average pressure may be selected according to the specifications of the processing to be performed in the planned gas processing plant.

It is emphasized that the components of the process data (203) and methods for obtaining the process data (203) are given only as examples and should not be considered limiting. One with ordinary skill in the art will readily appreciate that the process data (203) may include fewer or additional components from the above-described components without departing from the scope of this disclosure. Furthermore, the process data (203) may be obtained using different methods from the ones described above without departing from the scope of this disclosure.

Final process data (205) are obtained from the process data (203). The final process data (205) are intended to be sent as input to an AI model (209). In FIG. 2, the AI model (209) is assumed to be trained. In some implementations, the final process data (205) is the process data (203), without modification. In other implementations, the final process data (205) are obtained by pre-processing the process data (203). Pre-processing the process data (203) may be done in many ways and include various pre-processing steps. Examples of pre-processing steps that may be applied to the process data (203) include an encoding of categorical variables using methods known in the art, such as label encoding and one-hot encoding. Examples of pre-processing steps that may be applied to the process data (203) further include a mathematical transformation of one or more specific components of the process data (203), such as computing a logarithm of the one or more specific components.

In some embodiments, the pre-processing steps include the same pre-processing procedures as the ones that are used during a training phase of the AI model (209), known as training pre-processing steps. In some implementations, the training pre-processing steps include a normalization of training data samples. Accordingly, in such implementations, the pre-processing steps include a normalization of the process data (203) using the same normalization parameters as the ones used in the training pre-processing steps. The pre-processing steps may be performed using a pre-processing system (207). The pre-processing system (207) may be defined in many ways. In some embodiments, the pre-processing system (207) includes a computing machine, such as a computer. In some embodiments, the pre-processing system includes computing software, hosted and run on the computing machine. The computing software may include, for example, a programming language to program the pre-processing steps. The computing software may further include, for example, computing functions to perform computations involved in the pre-processing steps. The computing software may further include, for example, a user interface. The user interface may allow a user to send commands for the computing machine to perform the pre-processing steps and receive results from the computing machine.

The final process data (205) are sent, as input, to the AI model (209). The AI model (209) returns, as output, one or more predicted rupture exposure radii (211) for the production fluid. The AI model (209) may be configured in many ways. The AI model (209) may include, for example, a linear regressor, a non-linear regressor, a decision tree regressor, a random forest regressor, a Bayesian regressor, a support vector machine (SMV) regressor, or any combination thereof. In one or more embodiments, the AI model (209) includes an artificial neural network (ANN), such as a fully connected neural network, a convolutional neural network, a recurrent neural network, a long short-term memory (LSTM) network, a gated recurrent unit (GRU), a transformers model, or any combination of fully connected, convolutional, recurrent, LSTM, GRU, normalization, pooling, dropout and regularization layers. The AI model (209) may include other components or structures outside of the ones described herein without departing from the scope of this disclosure.

As stated, the production fluid includes one or more hazardous materials. The number of hazardous materials in the one or more hazardous materials is denoted as H and the hazardous materials are denoted as Hᵢ, for i=1, . . . , H. For each hazardous material among the one or more hazardous materials, one or more safety limits are selected for the hazardous material. A safety limit associated with a hazardous material is defined as a specific concentration of the hazardous material. For each hazardous material Hᵢ, the number of safety limits associated with the hazardous material Hᵢ is denoted as nᵢ, for i=1, . . . , H. The one or more safety limits associated with the hazardous material Hᵢ are denoted as S_{i,j}, for i=1, . . . , H, for j=1, . . . , nⱼ. The one or more safety limits for all the hazardous materials, S_{i,j}, for i=1, . . . , H, for j=1, . . . , nᵢ, form a set of one or more safety limits (213). The safety limits (213) are fed into the AI model (209) as part of the information required to output the RERi (211). The one or more predicted rupture exposure radii (211) include, for each hazardous material and each of the safety limits associated with the hazardous material, a predicted RER associated with the hazardous material and the safety limit. In other words, the one or more predicted rupture exposure radii (211) include

$$n = {\sum }_{i = 1}^{M} {n}_{i}$$

predicted RERi, denoted as \hat{R}_{i,j}, for i=1, . . . , H, for j=1, . . . , nᵢ, where \hat{R}_{i,j} denotes a predicted RER associated with the hazardous material Hᵢ and the safety limit S_{i,j}.

Each of the one or more safety limits S_{i,j}, associated with a hazardous material Hᵢ, is a specific concentration such that the AI model (209) computes a predicted RER for the hazardous material Hᵢ and the specific concentration. In some embodiments, the set of one or more safety limits (213) is selected arbitrarily by a user of the system (200). In other embodiments, the set of one or more safety limits (213) is selected in accordance with the risks posed by the one or more hazardous materials if their concentrations reach the safety limits. As a first example, in some implementations, a safety limit for a hazardous material presenting a chemical hazard may be defined as a specific concentration of the hazardous material that is thought to cause a specific health effect on individuals upon exposure. For instance, a safety limit for H₂S may be defined as 100 ppm because exposure to H₂S at 100 ppm during at least 48 hours may cause death. However, in other implementations, the set of one or more safety limits (213) is selected by a user of the system (200) regardless of any specific health effects of the one or more hazardous materials.

As a second example, in some implementations, a safety limit of a flammable hazardous material is based on the LFL of the flammable hazardous material. For instance, a safety limit may be defined as the LFL of the flammable hazardous material because it is thought that the flammable hazardous material can be ignited at a concentration equal to or above the LFL. In other implementations, the safety limit may be defined as a fraction of LFL, such as

$$\frac{1}{2} LFL .$$

It is noted that the concentration at which the flammable hazardous material may ignite, known as an ignition concentration, may be different from the LFL of the flammable hazardous material. The LFL of a flammable material is usually determined under specific environmental conditions. If the specific environmental conditions are not satisfied, the ignition concentration of the hazardous material may be different from its LFL. Furthermore, the accuracy of the LFL of the flammable hazardous material may depend on the accuracy of experiments and devices that were used to measure such LFL. Thus, in some implementations, the LFL of the flammable hazardous material may be seen as an estimate of the ignition concentration of the hazardous material, rather than an exact ignition concentration at which the flammable hazardous material will ignite. Thus, advantageously, using a fraction of the LFL as a safety limit, instead of the LFL, provides a security margin that may help mitigate the uncertainties of the ignition concentration.

In some implementations, the set of one or more safety limits (213) is defined by a safety regulator. The safety regulator may be part of a regulatory entity, such as a governmental agency responsible for environmental safety, or a private entity in charge of enforcing safety regulations. The safety regulator may be an individual, a plurality of individuals or a machine. In other implementations, the set of one or more safety limits (213) is defined by an organization in charge of the production facility.

As a specific example, the one or more hazardous materials may include two hazardous materials, namely, H₁=methane and H₂=hydrogene sulfide. One safety limit,

$${S}_{1 , 1} = \frac{1}{2} {LFL}_{1} ,$$

is selected for methane, where LFL₁ denotes the lower flammable limit of methane. Three safety limits, S_{2,1}=30 ppm, S_{2,2}=100 ppm and

$${S}_{2 , 3} = \frac{1}{2} {LFL}_{2}$$

are selected for hydrogen sulfide, where LFL₂ denotes the lower flammable limit of hydrogen sulfide. Thus, in this specific example, H=2, n₁=1, n₂=3 and the one or more predicted rupture exposure radii (211) include four predicted rupture exposure radii. A first predicted RER is associated with methane and

$$\frac{1}{2} {LFL}_{1} ,$$

a second predicted KEK is associated with hydrogen sulfide and 30 ppm, a third predicted RER is associated with hydrogen sulfide and 100 ppm and a fourth predicted RER is associated with hydrogen sulfide and

$$\frac{1}{2} {LFL}_{2} .$$

The AI model (209) may be configured in many ways. The AI model (209) may include a single machine learning (ML) model or multiple ML models. In cases where the one or more hazardous material include a single hazardous material and the set of one or more safety limits (213) includes a single safety limit associated with the single hazardous material, the one or more predicted rupture exposure radii (211) include a single predicted RER. In cases where the one or more hazardous materials include a plurality of hazardous materials or the set of one or more safety limits (213) includes a plurality of safety limits, the one or more predicted rupture exposure radii (211) include a plurality of rupture exposure radii.

In some implementations, the one or more predicted rupture exposure radii (211) may be split into one or more subsets, and the AI model (209) may include one or more ML models, each ML model computing a specific subset. Precisely, denoting n′ as the number of subsets and denoting Rⁱ as the i^{th} subset for i=1, . . . , n′, the AI model (209) may include n′ ML models, Mᵢ, i=1, . . . , n′, each ML model Mᵢ computing a distinct subset Rⁱ, for i=1, . . . , n′. In some implementations, n′=n, meaning that each subset Rⁱ is a single predicted RER and the AI model (209) includes as many ML models as the number of the one or more predicted rupture exposure radii (211), each ML model computing the single predicted RER. In the specific case where n′=n=1, the one or more predicted rupture exposure radii (211) include a single predicted RER and the AI model (209) includes a single ML model that computes the single predicted RER. In some implementations, n′=H and each subset Rⁱ includes the predicted RERi associated with a distinct hazardous material Hᵢ, for i=1, . . . , H, and all of the safety limits S_{i,j}, for j=1, . . . , nⱼ. In such implementations, the AI model (209) includes as many ML models as the number of hazardous materials. For i=1, . . . , H, each ML model Mᵢ computes the predicted RERi associated with the hazardous material Hᵢ, namely, all of the \hat{R}_{i,j}, for j=1, . . . , nᵢ.

In implementations in which the AI model (209) includes multiple ML models, each ML model may be configured in many ways, independently from the other ML model. For example, each ML model may include, independently from the other ML models, a linear regression, a non-linear regression, a decision tree regressor, a random forest regressor, a Bayesian regressor, a support vector machine, or any combination thereof. Each ML model may further include, independently from the other ML models, a neural network, such as a fully connected neural network, a convolutional neural network, a recurrent neural network, a LSTM network, a GRU, a transformers model, or any combination of fully connected, convolutional, recurrent, LSTM, GRU, normalization, pooling, dropout and regularization layers. Each ML model may include other structures outside of the ones described herein without departing from the scope of this disclosure.

The configuration of the AI model (209) may further depend on a structure of the input to the AI model (209). Two input scenarios are described in FIG. 2. In a first input scenario, the AI model (209) only receives the final process data (205) as input. In a second input scenario, the AI model (209) receives the final process data (205) and the set of one or more safety limits (213) as inputs. In some specific implementations of the second input scenario, the AI model (209) includes as many ML models as the number of hazardous materials H, the ML models denoted as Mᵢ, i=1, . . . , H. Each ML model Mᵢ, associated with a hazardous material Hᵢ is configured to receive, as inputs, the final process data (205), denoted as P, and an input safety limit, denoted as s. Each ML model Mᵢ is configured to return, as output, one predicted RER, Mᵢ(P, s), associated with the hazardous material Hᵢ and the input safety limit s. The predicted RERi associated with each hazardous material Hᵢ are computed by inputting, separately, each safety limit S_{i,j} to the ML model Mᵢ. In other words, the one or more predicted rupture exposure radii (211) are computed as \hat{R}_{i,j}=Mᵢ(P, S_{i,j}), for i=1, . . . , H, for j=1, . . . , nᵢ.

In one or more embodiments, the AI model (209) includes multiple stages. In such embodiments, the AI model (209) includes, at least, two ML models, namely, a first ML model and a second ML model. The second ML model receives, as input, an output from the first ML model. A specific example of a multi-stage implementation of the AI model (209) is depicted in FIG. 3. In FIG. 3, the AI model (209) includes an artificial neural network (ANN) (303) and a support vector machine (305). The ANN (303) receives, as input, the final process data (205). In some implementations, the ANN (303) further receives, as input, the set of one or more safety limits (213). The ANN (303) returns an input called an ANN output. The SVM (305) receives, as input, the ANN output and returns, as output, the one or more predicted rupture exposure radii (211). In some implementations, the SVM (305) further receives, as input, the final process data (205), the set of one or more safety limits (213), or both. The ANN (303) may include a fully connected neural network, a convolutional neural network, a recurrent neural network, a LSTM network, a GRU, a transformers model, or any combination of neural network (NN) layers, such as fully connected, convolutional, recurrent, LSTM, GRU, normalization, pooling, dropout and regularization layers. The ANN (303) may include other structures outside of the ones described herein without departing from the scope of this disclosure.

The ANN output can be of many types. In some implementations, the ANN (303) is trained to predict one or more RERi and the ANN output is a preliminary set of one or more predicted RERi. In such implementations, the SVM (305) is said to refine the preliminary set of one or more predicted RERi as the one or more predicted rupture exposure radii (211). In some implementations, the ANN output is a vector of numbers, known as an encoded vector, resulting from one or more NN layers. In such implementations, the ANN (303) is known as an encoder. In some specific implementation of an encoder, the ANN (303) may be, or include, an autoencoder or an embedding model. Generally, an encoder includes one or more NN layers from an auxiliary NN. The auxiliary NN receives, as input, the input to the ANN (303). The auxiliary NN is composed of a plurality of NN layers, including an output layer. The auxiliary NN is configured to perform a task and return, from the output layer, an output corresponding to the task. The encoded vector (i.e., the ANN output) is a result of an intermediate NN layer, among the plurality of NN layers, that is not the output layer. Thus, the ANN (303) is composed of the set of NN layers that transforms the input to the ANN (303) into the encoded vector. A notable example of an encoder is an auto-encoder. In some implementations, an autoencoder includes a plurality of NN layers run sequentially. The plurality of NN layers can be described as a first set of one or more NN layers and a second set of one or more NN layers, run sequentially. The autoencoder is trained to receive the input to the ANN (303) and return an output that is equal to the input to the ANN (303). After training, the second set of one or more NN layers is discarded and the encoder is formed by the first set of one or more NN layers. In other words, the encoded vector is an output from the first set of one or more NN layers.

The SVM (305) performs a support vector regression. The SVM (305) may be defined in many ways. The SVM (305) may include a mapping, known as a kernel, that transforms a vector input to the SVM (305), called a SVM input vector, into a transformed vector. In some implementations, the dimension of the transformed vector is larger than the dimension of the SVM input vector. The SVM (305) may further includes a hyperplane. The one or more predicted rupture exposure radii (211) may be computed such that a concatenated vector formed by concatenating the transformed vector and the one or more predicted rupture exposure radii (211) belongs to the hyperplane.

Returning to FIG. 2, a safety protocol (215) is determined based on the one or more predicted rupture exposure radii (211). The safety protocol (215) may be defined in many ways and include various components, known as one or more safety measures. In one or more embodiments, a vicinity distance is defined based on the RERi associated with the one or more hazardous materials. For example, the vicinity distance may be defined as a specific RER associated with a specific hazardous material and a specific safety limit. As another example, the vicinity distance may be defined as a maximum of the RERi associated with the one or more hazardous materials. In some implementations, the safety measures include an emergency plan to be communicated to a neighboring population living at a distance of less than the vicinity distance from the production facility. The emergency plan may include, for example, an evacuation map, a prescription for an antidote or a health plan.

In some embodiments, the production facility is a planned production facility and the safety protocol (215) may include a minimum distance requirement. The minimum distance requirement imposes that the production facility be built farther than the vicinity distance from any human population or built structure.

In some embodiments, the safety protocol (215) includes a building specification that imposes a constraint to the structure of the production facility based on the vicinity distance. Examples of building specifications include that a thickness of a wall of the conveying equipment be greater than a minimum thickness. In some implementations, the minimum thickness is defined arbitrarily, based on a risk of rupture of the wall and economic factors. In some implementations, the minimum thickness is a function of the vicinity distance that increases with an increase of the vicinity distance. In cases where the production facility is a production well, the wall may be defined, for example, as a casing of the wellbore. In cases where the production facility is a pipeline, the wall may be defined, for example, as a boundary of the pipe. Examples of building specifications further include a property of a construction material of which the wall should be made. Examples of properties for the construction material include a compressive strength, an elasticity and a thermal conductivity of the construction material. As a specific example, in some implementations, a minimum compressive strength is imposed to the construction material if the vicinity distance exceeds a certain vicinity threshold. In some implementations, a minimum compressive strength is defined for each range within a plurality of ranges of the vicinity distance. Examples of properties for the construction material further include a type for the construction material, such as cement or metal.

In some implementations, the location of the production facility is known as a populated location if a population or a built structure is located within the vicinity distance from the production facility. In some implementations, one or more safety measures, known as population-dependent safety measures, may be defined based on whether the production facility is located in a populated area. For instance, in some implementations, the building specification is included in the safety protocol (215) only if the production facility is located in a populated area.

In some embodiments, the safety protocol (215) is determined by a safety planning system. The safety planning system may include a team of scientists that determine the safety protocol (215), the scientists including, for example, one or more chemists, mechanical engineers, material engineers, environmental specialists, health practitioners, or any combination thereof. The safety planning system may further include a computing system, a visualization tool, a workstation or any combination thereof in order to perform a safety analysis for determining the safety protocol (215). In some implementations, the safety planning system is further structured to select the set of one or more safety limits (213). In one or more embodiments, the safety planning system receives inputs from stakeholders in the oil industry or a governmental entity. Examples of stakeholders include, but are not limited to geologists, healthcare practitioners, a natural resource company management and a government participant. In some embodiments, the safety planning system belongs to the safety regulator. In other implementations, the safety planning system belongs to the organization in charge of the production facility.

A facility operation (217) is performed in accordance with the safety protocol (215). The facility operation (217) may be defined in many ways. The facility operation (217) may depend on whether the production facility is a planned production facility or an extant production facility. In a first context, the production facility is a planned production facility and the facility operation (217) includes building the production facility at a planned construction location. In scenarios where the safety protocol (215) includes an emergency plan for a neighboring population, performing the facility operation (217) in accordance with the safety protocol (215) includes building the production facility and communicating the emergency plan to the neighboring population before or during a construction of the production facility. In scenarios where the safety protocol (215) includes a minimum distance requirement, performing the facility operation (217) in accordance with the safety protocol (215) includes building the production facility at a distance, from a population or a built structure, of at least the vicinity distance. In scenarios where the safety protocol (215) includes a building specification, performing the facility operation (217) in accordance with the safety protocol (215) includes building the production facility in compliance with the building specification.

In a second context, the production facility is an extant production facility. In scenarios where the safety protocol (215) includes an emergency plan for a neighboring population, the facility operation (217) may include running the production facility for its intended purpose. Performing the facility operation (217) in accordance with the safety protocol (215) includes running the production facility and communicating the emergency plan to the neighboring population before or while running the production facility. In some scenarios, the facility operation (217) includes a maintenance operation of the production facility and the safety protocol (215) includes a building specification. In such scenarios, performing the facility operation (217) in accordance with the safety protocol (215) includes conducting the maintenance operation in compliance with the building specification. As a specific example, the maintenance operation may include replacing a part of the production facility and the building specification may include a construction material for that part. In this specific example, performing the facility operation (217) in accordance with the safety protocol (215) includes replacing the part using the specified construction material. In some embodiments, the production facility does not comply with the safety protocol (215) and the facility operation (217) includes updating the production facility in order bring the production facility to compliance with the safety protocol (215). For instance, in some embodiments, the safety protocol (215) includes a minimum thickness of a wall of the conveying equipment. However, the wall of the conveying equipment of the production facility is slimmer than the minimum thickness. In this situation, the facility operation (217) may include updating the wall in order to comply with the minimum thickness.

There are many scenarios in which the production facility may not comply with the safety protocol (215) and may need to be updated. For instance, in a first scenario, the safety protocol (215) includes a population-dependent safety measure, and the production facility is located at a construction location that, at the time of building the production facility, was not populated. However, over time, the location of the production facility has become populated. In such a scenario, the production facility may be updated in order to comply with the population-dependent safety measure. In a second scenario, the production facility is planned to be re-activated after being abandoned and a degradation of the conveying equipment in the production facility causes the production facility to not comply with the safety protocol (215). In a third scenario, there is a change in a regulation defining the safety protocol (215) and, due to such change, the production facility no longer complies with the safety protocol (215).

In one or more embodiments, the facility operation (217) is performed by a service system. The service system may be defined in many ways. The service system may include service personnel and service equipment for performing the facility operation (217). Service personnel may include various service workers. Examples of service workers that may be part of the service personnel include one or more analysts, engineers, technicians, construction workers and maintenance workers who plan and perform the facility operation. The service equipment may include various components. Examples of components of the service equipment may include construction materials, such as cement, sand, water and metal. Examples of components of the service equipment may further include tools, such as a hammer, a drill, a wrench, a clamp and a chisel. In some implementations, the production facility is a production well and the service equipment may include a high-pressure pump, a wellhead assembly, a perforating gun, a tank, and coil tubing. The service equipment may further include heavy machinery, such as a crane and an excavator. The service system may include one or more departments, such as an engineering department, a human resource department, a construction department, a maintenance department, a mechanical department, a legal department, a sales department, a research and development department and a Health, Safety and Environment (HSE) department.

Artificial intelligence models typically involve a training phase and a testing phase, both using previously acquired data. Supervised machine-learned models require data samples of input and associated output (i.e., target) pairs in order to learn a desired functional mapping. The data samples form a dataset of data samples. In the context of this disclosure, the data samples are extracted from experimental data. Thus, the AI model (209) is trained using experimental data. The experimental data include, at least, sample process data and corresponding values of RERi associated with the hazardous materials and certain concentration levels. One with ordinary skill in the art will readily appreciate that a full discussion of the training of every possible configuration of the AI model (209) is not possible nor required to describe the systems and methods in this disclosure. Therefore, a brief discussion of some example configurations is provided herein.

The AI model (209) predicts the one or more predicted rupture exposure radii (211), denoted as a set \hat{R}={\hat{R}_{i,j}, i=1, . . . , H, j=1, . . . , nᵢ}. The AI model (209) includes one ML model or multiple ML models. Each ML model is trained, separately or jointly, and requires a specific dataset of data samples. In a first example configuration, the AI model (209) includes a single ML model, M₁, configured to receive, as inputs, process data P and return, as output, a the one or more predicted rupture exposure radii (211), \hat{R}=M₁ (P). In this first example configuration, the input of a data sample for the ML model M₁ is composed of process data, and the output of a data sample for the ML model M₁ is composed of a set of RERi, R={R_{i,j}, i=1, . . . , H, j=1, . . . , nᵢ}, where R_{i,j} is a RER associated with a hazardous material Hᵢ and a safety limit S_{i,j}. In a second example configuration, the AI model (209) includes a single ML model, M₁, configured to receive, as inputs, process data P and a set of one or more concentration levels c={c_{i,j}, i=1, . . . , H, j=1, . . . , nᵢ} and return, as output, the one or more predicted rupture exposure radii (211), namely, \hat{R}=M₁(P, c). In this second example configuration, the input of a data sample for the ML model M₁ is composed of process data and a set of concentration levels C={C_{i,j}, i=1, . . . , H, j=1, . . . , nᵢ}, and the output of a data sample for the ML model M₁ is composed of a set of RERi, R={R_{i,j}, i=1, . . . , H, j=1, . . . , nᵢ}, where R_{i,j} is a RER associated with a hazardous material Hᵢ and a concentration level C_{i,j}. The concentration levels C_{i,j}, in the data samples, need not be equal to the one or more safety limits S_{i,j}.

In some implementations, the AI model (209) includes H ML models Mᵢ, namely, one ML model for each hazardous material Hᵢ, i=1, . . . , H. In such implementations, each for a ML model Mᵢ make use of a specific dataset of data samples. A few scenarios are described herein for illustration purposes. In a third example configuration, each ML model Mᵢ is configured to receive, as input, process data P and return, as output, one or more predicted RERi associated with the hazardous material Hᵢ, denoted as \hat{R}ᵢ=Mᵢ(P), where, \hat{R}ᵢ is the set {\hat{R}_{i,j}. j=1, . . . , nᵢ}. In this third example configuration, the input of a data sample for a ML model Mᵢ is composed of process data, and the output of a data sample for a ML model Mᵢ is composed of a set of RERi, Rᵢ={R_{i,j}, j=1, . . . , nᵢ}, where R_{i,j} is a RER associated with a hazardous material Hᵢ and a safety limit S_{i,j}. In a fourth example configuration, each ML model Mᵢ is configured to receive, as input, process data P and a set of one or more concentration levels c={cⱼ, j=1, . . . , nᵢ} and return, as output, one or more predicted RERi associated with the hazardous material Hᵢ, denoted as \hat{R}ᵢ=Mᵢ(P, c). In this fourth example configuration, the input of a data sample for a ML model Mᵢ is composed of process data and a set of concentration levels C={Cⱼ, j=1, . . . , nᵢ}, and the output of a data sample for a ML model Mᵢ is composed of a set of RERi, Rᵢ={R_{i,j}, j=1, . . . , nᵢ}, where R_{i,j} is a RER associated with a hazardous material Hᵢ and a concentration level Cⱼ. In a fifth example configuration, each ML model Mᵢ is configured to receive, as input, process data P and a single concentration level c and return, as output, a single predicted rupture exposure radius associated with the hazardous material Hᵢ and the concentration level c, \hat{R}ᵢ=Mᵢ(P, c). In this fifth example configuration, the input of a data sample for a ML model Mᵢ is composed of process data and a single concentration level C and the output of a data sample for a ML model Mᵢ is composed of a RER, Rᵢ, associated with a hazardous material Hᵢ and a concentration level C.

In one or more embodiments, a specific dataset of data samples, for any ML model included in the AI model (209), is split into a training dataset and a testing dataset. The data samples of the training dataset are called training data samples. The data samples of the testing dataset are called testing data samples. It is common practice to split the dataset in a way that the training dataset contains more data samples than the testing dataset. Because data splitting is a common practice when training and testing a machine-learned model, it is not described in detail in this disclosure. One with ordinary skill in the art will recognize that any data splitting technique may be applied to the dataset without any consequence on the scope of this disclosure. The ML model is then trained as a functional mapping that optimally matches the inputs of the training data samples to the associated outputs of the training data samples.

In one or more embodiments, the data samples undergo one or more training pre-processing steps. The training pre-processing steps may be defined in many ways. The pre-processing steps may include operations performed on the inputs of the data samples, the output data samples, or both. For example, the training pre-processing steps may include an encoding of categorical variables of the inputs of the data samples, the outputs of the data samples, or both, using methods known in the art, such as label encoding and one-hot encoding. Examples of training pre-processing steps may further include a mathematical transformation of one or more specific components of the inputs of the data samples, outputs of the data samples, or both, such as computing a logarithm of the one or more specific components of the inputs of the data samples, or the outputs of the data samples, or both. In some embodiments, the training pre-processing steps include a normalization of the inputs of the data samples using a method known in the art, such as a min-max scaling, scaling to unit and standard scaling. Denoting n>1 as the number of training data samples, n_{c}≥1 as the number of components of the input of a data sample and

$${p}_{i}^{j}$$

as the j^{th} component of the i^{th} training data sample, for 1≤i≤n, for 1≤j≤n_{c}, a normalized value

$${p}_{i}^{j , norm} for {p}_{i}^{j}$$

may be computed using a normalization procedure. Examples of normalization procedures known in the art for computing

$${p}_{i}^{j , norm}$$

include:

$${p}_{train}^{j , min}$$

$$Min - max scaling \text{:} {p}_{i}^{j , norm} = \frac{{p}_{i}^{j} - {p}_{train}^{j , min}}{{p}_{train}^{j , max} - {p}_{train}^{j , min}} , \qquad EQ . 1$$

$$Scaling to unit \text{:} {p}_{i}^{j , norm} = \frac{{p}_{i}^{j}}{‖ {p}_{train}^{j} ‖} , \qquad EQ . 2$$

$$Standard scaling \text{:} {p}_{i}^{j , norm} = \frac{{p}_{i}^{j} - {\overline{p}}_{train}^{j}}{{s}_{train}^{j}} . \qquad EQ . 3$$

In EQ. 1,

$${p}_{train}^{j , min} = {min}_{1 \leq i \leq n} {p}_{i}^{j}$$

is the minimum value of the j^{th} component across the training data samples and

$${p}_{train}^{j , max} = {max}_{1 \leq i \leq n} {p}_{i}^{j}$$

is the maximum value of the j^{th} component across the training data samples. In EQ. 2,

$$‖ {p}_{train}^{j} ‖$$

denotes a norm of the vector

$${p}^{j} := \{ {p}_{i}^{j} , 1 \leq i \leq n \} ,$$

such as a l¹-norm or a l²-norm. In EQ. 3,

$${\overline{p}}_{train}^{j} = \frac{{\sum }_{i = 1}^{n} {p}_{i}^{j}}{n}$$

is the mean value of the j^{th} component across the training data samples and

$$s = \sqrt{\frac{{\sum }_{i = 1}^{n} {( {p}_{i}^{j} - {\overline{p}}_{train}^{j} )}^{2}}{n - 1}}$$

is the sample standard deviation of the j^{th} component across the training data samples.

In some embodiments, the training pre-processing steps make use of pre-processing parameters that are determined for the training data samples only. For example, the minimum value

$${p}_{train}^{j , min}$$

and the maximum value

$${p}_{train}^{j , max}$$

in EQ. 1 are pre-processing parameters computed using the values

$${p}_{i}^{j}$$

form the training data samples. The training pre-processing steps are also applied to the testing data samples using the same pre-processing parameters. For instance, denoting m≥1 as the number of testing data samples and

$${\tilde{p}}_{i}^{j}$$

as the j^{th} component of the i^{th} testing data sample, for 1≤i≤m, for 1≤j≤n_{c}, the min-max scaling normalization for the

$${\tilde{p}}_{i}^{j}$$

is computed using the pre-processing parameters

$${p}_{train}^{j , min} and {p}_{train}^{j , max}$$

as:

$${\tilde{p}}_{i}^{j , norm} = \frac{{\tilde{p}}_{i}^{j} - {p}_{train}^{j , min}}{{p}_{train}^{j , max} - {p}_{train}^{j , min}} . \qquad EQ . 4$$

Pre-processing the training data samples using the training pre-processing steps results in pre-processed training data samples. Pre-processing the testing data samples using the training pre-processing steps results in pre-processed testing data samples. Final training data samples are defined as either the training data samples if no pre-processing is performed on the training data samples, or the pre-processed training data samples if pre-processing is performed on the training data samples. Similarly, final testing data samples are defined as either the testing data samples if no pre-processing is performed on the testing data samples, or the pre-processed testing data samples if pre-processing is performed on the testing data samples. It is noted that in some embodiments, the training pre-processing steps include discarding some of the training data samples or testing data samples, or both. Therefore, the number of final training data samples is not necessarily assumed to be the same as the number of training data samples. Similarly, the number of final testing data samples is not necessarily assumed to be the same as the number of testing data samples.

Once trained, a given ML model of the AI model (209) is validated by computing a metric for the final testing data samples, in accordance with one or more embodiments. Denoting d≥1 as the number of final testing data samples, the input of the i^{th} final testing data sample is denoted as xᵢ, for i=1, . . . , d. The output of the i^{th} final testing data sample includes one or more numerical components that may be arranged as a vector yᵢ, for i=1, . . . , d. The output of the given ML upon receiving xᵢ as input also includes one or more numerical components, that may be arranged as a vector ŷᵢ, for i=1, . . . , d. Examples of metrics that may be used to validate the given ML model include any scoring or comparison metrics known in the art, including but not limited to: a mean absolute error (MAE), a mean squared error (MSE), a root mean square error (RMSE) and a coefficient of determination (R²), defined respectively as:

$$M A E = \frac{1}{d} {\sum }_{i = 1}^{i = d} \vert {\hat{y}}_{i} - {y}_{i} \vert , \qquad EQ . 5$$

$$M S E = \frac{1}{d} {\sum }_{i = 1}^{i = d} {\vert {\hat{y}}_{i} - {y}_{i} \vert}^{2} , \qquad EQ . 6$$

$$R M S E = \sqrt{\frac{1}{d} {\sum }_{i = 1}^{i = d} {\vert {\hat{y}}_{i} - {y}_{i} \vert}^{2}} , \qquad EQ . 7$$

$${R}^{2} = 1 - \frac{{\sum }_{i = 1}^{i = d} {\vert {\hat{y}}_{i} - {y}_{i} \vert}^{2}}{{\sum }_{i = 1}^{i = d} {\vert {y}_{i} - \overline{y} \vert}^{2}} . \qquad EQ . 8$$

In EQ. 5-EQ. 8,

$$\overline{y} = \frac{1}{d} {\sum }_{i = 1}^{i = d} {y}_{i} .$$

The notation ∥ denotes a vectorial norm, such an l₂ norm. The comparison functions in EQs. 5-8 can also be applied to the final training data samples, by replacing d with the number of final training data samples, yᵢ as the output of the i^{th} final training data sample and ŷᵢ as the output of the ML model upon receiving the input of the i^{th} final training data sample, xᵢ, as input.

As stated, the data samples are extracted from experimental data. The experimental data can be obtained in many ways and a few examples are provided herein. In one or more embodiments, the experimental data are taken from an experimental database created in the past. In other embodiments, all, or part of the experimental data are captured though an experimental framework. Two example experimental frameworks are described herein. In a first experimental framework, a plurality of sample experiments is conducted. Each sample experiment includes selecting a set of sample process data and forming a sample production fluid containing at least one of the one or more hazardous materials. The sample fluid is formed in accordance with the set of sample process data. For instance, if the set of sample process data includes a first volume concentration of a first hazardous material in the sample production fluid, the sample production fluid must include the first hazardous material with the first volume concentration. Each sample experiment further includes releasing the sample production fluid at a release location in a controlled environment. The sample production fluid is released in accordance with the set of sample process data. For instance, if the set of sample process data includes a first production fluid flow rate, the sample production fluid is released at a rate equal to the first production fluid flow rate. In some embodiments, releasing the sample production fluid in the controlled environments may be seen as simulating a rupture of equipment conveying the sample production fluid. The controlled environment may be defined in several ways. The control environment may be or include, for example, a laboratory, a closed experimental facility or an open area of the Earth considered to be located far for any population.

In a first sample experiment, a first set of sample process data is selected. A first sample production fluid is formed and released in the controlled environment according to the first set of sample process data. One or more concentrations of a first hazardous material in the first sample production fluid are measured at one or more measured distances from the release location. Such measurements result in a first set of one or more measured concentrations for the first hazardous material. Each measured concentration in the first set of one or more measured concentrations is associated with the first hazardous material and a distinct measured distance, from the release location, at which the measured concentration is measured. Each measured distance constitutes an observed RER associated with the first hazardous material and the measured concentration. Thus, the one or more measured distances form a first set of one or more observed RERi associated with the first hazardous material. Each observed RER in the first set of one or more observed RERi is associated with a measured concentration among the first set of one or more measured concentrations.

The set of one or more safety limits (213) includes one or more safety limits associated with the first hazardous material. In cases where the AI model (209) is configured to only receive the final process data (205) as input without receiving the set of one or more safety limits (213), the first set of one or more measured concentrations must include the one or more safety limits associated with the first hazardous material. In other words, each measured distance is intentionally chosen as a distance where the concentration of the first hazardous material is equal to a safety limit associated with the first hazardous material. In cases where the AI model (209) is configured to receive the final process data (205) and the set of one or more safety limits (213) as inputs, no restrictions need to be made regarding the first set of one or more measured concentrations. In the context of the first sample experiment, the measurements are repeated for each hazardous material contained in the first sample production fluid. Accordingly, the first sample experiment results in one or more observed RERi. Each observed RER in the one or more observed RERi is associated with a given hazardous material in the first sample production fluid and a given measured concentration of the given hazardous material. A first experimental data point is formed. The first experimental data point includes the first set of sample process data used in the first sample experiment and the one or more observed RERi measured from the first sample experiment. The first experimental data point may further include a first list of the one or more hazardous materials used in the first sample experiment and the measured concentrations from the first sample experiment.

Each sample experiment in the plurality of sample experiments is performed in a similar fashion to the first sample experiment. Accordingly, the plurality of sample experiments results in a plurality of experimental data points. In other words, each sample experiment results in an experimental data point with the same format as the first experimental data point. As such, each experimental data point, from a sample experiment, includes a set of sample process data used in sample experiment and one or more observed RERi measured from the sample experiment. The experimental data point, from a sample experiment, may further include a list of the one or more hazardous materials used in the sample experiment and the measured concentrations from the sample experiment. The experimental data include the plurality of sample data points.

In a second experimental scenario, rupture experimental data points are captured after ruptures of conveying equipment that occur in existing production facilities. For instance, a first rupture experimental data points is obtained after a first rupture of conveying equipment occurs at a first rupture location in a first existing production facility. Process data, re-named as a first set sample process data, are measured at a time when the first rupture occurs using one or more sensors installed in the first existing production facility. When the first rupture occurs, a first production fluid escapes from the first existing production facility. Measurements are then taken in a similar fashion to the first experimental framework. For each hazardous material in the first production fluid, one or more concentrations are measured at one or more measured distances from the first rupture location, thereby resulting in one or more measured concentrations for the hazardous material. Each measured distance constitutes an observed RER associated with the hazardous material and the measured concentration measured at the measured distance. Thus, the one or more measured distances constitute a set of one or more observed RERi associated with the hazardous material. The sets of one or more observed RERi associated with all the hazardous materials form one or more observed RERi associated with the first rupture. A first rupture experimental data point is formed from the first rupture. The first rupture experimental data point includes, at least, the first set of sample process data and the one or more measured RERi associated with the first rupture. The first rupture experimental data point is included in the experimental data. Similar measurements can be taken from a plurality of ruptures, thereby resulting in a plurality of rupture experimental data points included in the experimental data.

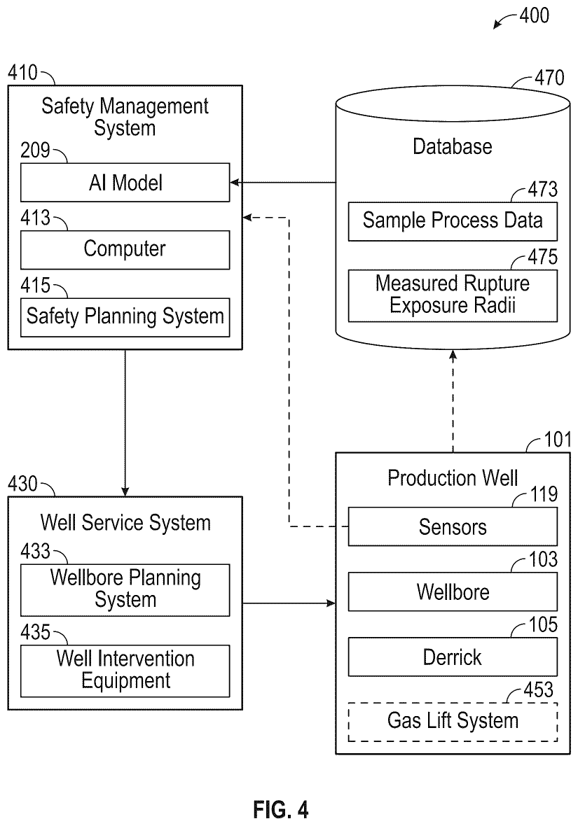

FIG. 4 depicts a safety system (400) for performing a facility operation for the production well (101). The system in FIG. 4 includes a safety management system (410), a well service system (430), the production well (101) and an experimental database (470). The production well (101) is configured to produce a production fluid. The production well (101) includes, as described in FIG. 1, a wellbore (103), a derrick (105) and one or more sensors (119), configured to acquire process data. In some implementations, the production well (101) further includes a gas-lift system (453) that aims at optimizing the extraction of the production fluid. FIG. 4 includes, at least, two embodiments for the production well (101). In a first embodiment, the production well (101) is an extant production well and produces the production fluid. In a second embodiment, the production well (101) is a planned production well and is expected to produce the production fluid.

The safety management system (410) receives process data (203) for the production well (101). In embodiments where the production well (101) is an extant production well, the process data (203) are acquired by the one or more sensors (119) and sent to the safety management system (410). In embodiments where the production well (101) is a planned production well, the process data (203) are projected process data, as explained in the description of FIG. 2. The safety management system (410) includes the AI model (209), configured to receive the final process data (205) based on the process data (203). In some embodiments, the final process data (205) is the process data (203). In other embodiments, the final process data (205) is obtained by pre-processing the process data (203), as explained in the description of FIG. 2. The AI model (209) is configured to the compute the one or more predicted rupture exposure radii (211) for the production fluid. The safety management system (410) further includes a computer (413) on which the AI model (209) is hosted and run. In one or more embodiments, the computer (413) is further used to train the AI model (209), test the AI model (209), or both. The one or more predicted rupture exposure radii (211) are sent to a safety planning system (415).

The safety planning system (415) is configured to determine the safety protocol (215), based on the one or more predicted rupture exposure radii (211). As previously described in this disclosure, the safety planning system (415) may include various components, such as, for example, a computing system, a visualization tool, a workstation, a team of scientists that determine the safety protocol (215), or any combination thereof. In some implementations, the safety planning system (415) is further structured to select the set of one or more safety limits (213). In one or more embodiments, the safety planning system (415) receives inputs from stakeholders in the oil industry or a governmental entity such as geologists, healthcare practitioners, a natural resource company management and a government participant. In some embodiments, the safety planning system (415) belongs to the safety regulator. In other implementations, the safety planning system (415) belongs to the organization in charge of the production well (101). The safety planning system (415) may further include a safety database containing a list of health effects of the hazardous materials upon exposure at various concentrations. In one or more embodiments, the health effects are analyzed and determined by a health agency. At the time of writing this disclosure, health effects of hydrogen sulfide are determined, for example, by the Occupational Safety and Health Administration. In one or more embodiments, the safety database further includes a list of safety measures that may be included in the safety protocol (215), such as, for example, a minimum distance requirement or a building specification for the production well (101). In one or more embodiments, the safety measures are imposed by a safety regulation enforced by a law-enforcement agency.

The well service system (430) receives the safety protocol (215) from the safety management system (410). The well service system (430) is configured to perform the facility operation (217), known as a well operation in FIG. 4. The well operation is performed in accordance with the safety protocol (215). The well service system (430) may include well service personnel for well operation. Service personnel may include various well service workers. Examples of well service workers that may be part of the well service personnel include one or more analysts, engineers, technicians, construction workers and maintenance workers. The well service personnel may include a first team of well service workers who perform the well operation. The well service system (430) includes a well planning system (433). The well planning system (433) is configured to plan the well operation. The well planning system is configured to allocate resources to the well operations, such as, for examples, human resources, a timeline for tasks included in the well operation, guidelines for the well operation, and guidelines for using the well intervention equipment (435). The well planning system (433) may further include analysis tools, such as computer processors and visualization software. The well planning system (433) may further include a second team of well service workers who plan the well operation. In some embodiments, the first team and the second team overlap or are a same team. The well planning system (433) may further include a database, in which geographical and geo-political information is stored about the production well (101) and a location of the production well (101). The well service system (430) may include one or more departments, such as an engineering department, a human resource department, a construction department, a maintenance department, a mechanical department, a legal department, a sales department, a research and development department and a Health, Safety and Environment (HSE) department.

The well service system (430) includes well intervention equipment (435). The well intervention equipment (435) may include various components allowing for performing the well operation. Examples of components of the well intervention equipment (435) include, but are not limited to, a high-pressure pump that pumps wellbore fluid into the wellbore, a wellhead assembly that controls the wellbore fluid flow from the surface, a perforating gun configured to perforate the well, a tank and a fluid-sand separator. Examples of components of the well intervention equipment (435) further include coil tubing for removing debris from the wellbore and a hydraulic blowout preventer configured to prevent an uncontrolled wellbore fluid release. Examples of components of the well intervention equipment (435) further include a hydraulic snubbing unit, configured to run or pull tubulars in and out of the wellbore, and a bullheading manifold configured to push drilling mud, debris, or blockages downhole. Examples of components of the well intervention equipment (435) further include building materials, such as cement, sand, water and metal. In embodiments where the well operation includes building the production well (101), the well intervention equipment (435) may further include heavy machinery, such as a crane and an excavator.

The experimental database (470) includes the experimental data. As previously described in this disclosure, the experimental data includes sample process data (473) and measured rupture exposure radii (475). As previously described, the experimental data may be acquired, for example, in two experimental scenarios. In the first experimental scenario, a plurality of sample experiments are conducted and experimental data points are obtained from the plurality of sample experiments. In the second scenario, rupture experimental data points are obtained after ruptures of conveying equipment occur in existing production facilities. The experimental database (470) is used to construct data samples for the training and testing of the AI model (209). In one or more embodiments, the production well (101) is an extant production well and a rupture of the wellbore occurs throughout the life of the production well (101). Following the rupture of the wellbore, one or more supplemental rupture experimental data points may be acquired as previously described in the second experimental scenario. The supplemental rupture experimental data points may be appended to the experimental database (470) and used to fine-tune the AI model (209). Fine-tuning the AI model (209) may be run on the computer (413) in accordance with one or more embodiments.

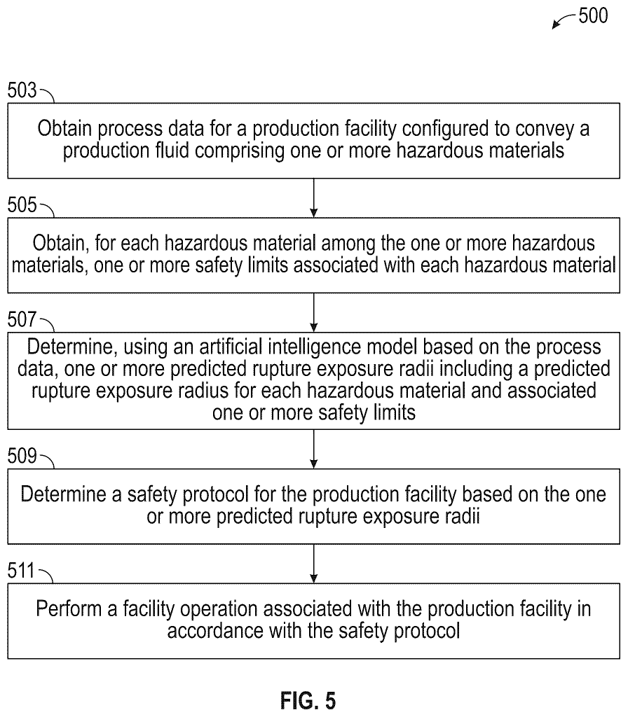

FIG. 5 depicts a method (500) for determining one or more rupture exposure radii for a production fluid. The method (500) further includes performing, accordingly, a facility operation on a production facility configured to convey the production fluid. In Step 503, process data are obtained for the production facility. The production facility may be of various types. For instance, in some embodiments, the production facility includes a production well configured to convey a production fluid from a hydrocarbon reservoir to the surface, through a wellbore, such as the production well (101) in FIG. 1. In other embodiments, the production facility includes a pipeline that conveys a production fluid from one geographical location to another geographical location. In other embodiments, the production facility includes a processing facility, such as a gas processing plant, that transforms and conveys a production fluid from one processing unit to another processing unit. The production fluid may be conveyed using conveying equipment, such as a wellbore or a pipe.

The process data in Step 503 are similar to the process data (203) in FIG. 2. In one or more embodiments, the production facility is an extant production facility in operation and the process data are referred to as measured process data. The measured process data may include, for example but not limited to, a measured production fluid flow rate in the production facility, a measured concentration of a material in the production fluid, such as a measured molecular concentration of H₂S, and/or a measured ratio between two materials or phases in the production fluid, such as a measured oil-to-gas ratio. In other embodiments, the production facility is a planned production facility to be constructed and the process data are referred to as projected process data. The projected process data may include, for example but not limited to, a projected maximum production fluid flow rate in the production facility, a projected concentration of a material in the production fluid, such as a projected molecular concentration of H₂S, and a projected ratio between two materials or phases in the production fluid, such as a projected oil-to-gas ratio.

In a similar fashion to the production fluid in the system (200), the production fluid in Step 503 contains one or more hazardous materials. Examples of hazardous materials that may be contained in the production fluid include a flammable hydrocarbon that presents a fire hazard, such as petroleum, methane, ethane and natural gas liquids. Examples of hazardous materials that may be contained in the production fluid further include a toxic gas that presents a chemical hazard, such as hydrogen sulfide (H₂S). Some hazardous material may present multiple hazards. For instance, H₂S is flammable and thus presents a flammable hazard in addition to a chemical hazard. In case of a rupture of the conveying equipment, the one or more hazardous materials from the production fluid may escape from the production facility and propagate, thereby posing a risk to neighboring populations, environment and built structures. In some embodiments, the risk posed by a hazardous material at a specific location depends on a concentration of the hazardous material at the specific location.

In Step 505, one or more safety limits are obtained for each hazardous material. The one or more safety limits associated with all the hazardous materials form a set of one or more safety limits in a similar fashion to the set of one or more safety limits (213) in FIG. 2. A safety limit associated with a hazardous material is defined as a specific concentration of the hazardous material. In one or more embodiments, the set of one or more safety limits is selected arbitrarily by a user of the method (500). In other embodiments, the one or more safety limits for a hazardous material are selected in accordance with the risks posed by the hazardous material if their concentrations reach the safety limits. For instance, in some implementations, a safety limit for a flammable material is based on a lower flammable limit of the flammable material. Further, in some implementations, a safety limit for a toxic material is based on a toxicity concentration that is thought to cause a specific heath effect on individuals upon exposure.

In Step 507, one or more predicted rupture exposure radii (RERi) are determined for the production fluid, in a similar fashion to the one or more predicted rupture exposure radii (211) in FIG. 2. The one or more predicted rupture exposure radii include, for each hazardous material among the one or more hazardous materials and each safety limit among the one or more safety limits associated with the hazardous material, a predicted rupture exposure radius (RER) associated with the hazardous material and the safety limit. A predicted RER associated with a hazardous material and a safety limit is defined as a prediction of a RER associated with the hazardous material and the safety limit. In some embodiments, the production fluid may escape the production facility in case of a rupture of the conveying equipment at a rupture location. In some embodiments, a RER associated with the hazardous material and the safety limit is defined as a maximum distance from a rupture location at which the hazardous material would have a concentration equal to the safety limit.

The one or more rupture exposure radii are determined using an artificial intelligence (AI) model based on the process data from Step 503. The AI model receives, as input, final process data, similar to the final process data (205) in FIG. 2. In some implementations, the final process data are the process data from Step 503. In other implementations, the final process data are obtained by pre-processing the process data. The AI model is configured in the same way as the AI model (209) in FIG. 2. As such, the AI model in Step 507 may include one or more machine learning models, each of which including, for example but not limited to, as a linear regressor, a non-linear regressor, a decision tree regressor, a random forest regressor, a Bayesian regressor, a support vector machine regressor, or any combination thereof. In some implementations, the AI model in Step 507 includes a neural network, such as a fully connected neural network, a convolutional neural network, a recurrent neural network, a long short-term memory (LSTM) network, a gated recurrent unit (GRU), a transformers model, or any combination of fully connected, convolutional, recurrent, LSTM, GRU, normalization, pooling, dropout and regularization layers. The AI model in Step 507 may include other components or structures outside of the ones described herein without departing from the scope of this disclosure. The AI model may be trained and tested using experimental data. The experimental data may be acquired, for example, from one or more of the two experimental scenarios previously defined in this disclosure.

The output of the AI model in Step 507 can be applicable to different types of wells, such as sour wells and sweet wells. For example, sour gas wells shall be considered in this disclosure to have three RERs:
100 parts per million (ppm) Hydrogen Sulfide (H2S) RER (RER100 ppm),
30 ppm H2S RER (RER30 ppm)
½ LFL RER (RER½LFL).
Sweet gas wells would only have a RER½LFL.

In Step 509, the one or more predicted rupture exposure radii are used to determine a safety protocol for the production facility. The safety protocol in Step 509 is similar to the safety protocol (215) in FIG. 2. As such, the safety protocol in Step 509 may include one or more of an emergency plan, a minimum distance requirement and a building specification. In one or more embodiments, a vicinity distance is defined based on the RERi associated with the one or more hazardous materials. For example, the vicinity distance may be defined as a specific RER associated with a specific hazardous material and a specific safety limit. As another example, the vicinity distance may be defined as a maximum of the RERi associated with the one or more hazardous materials. In some implementations, the location of the production facility is known as a populated location if a population or a built structure is located within the vicinity distance from the production facility. In some implementations, one or more safety measures, known as population-dependent safety measures, may be defined based on whether the production facility is located in a populated area. For instance, in some implementations, a building specification is included in the safety protocol only if the production facility is located in a populated area.

In Step 511, a facility operation, associated with the production facility, is performed in accordance with the safety protocol from Step 509. The facility operation in Step 511 is similar to the facility operation (217) in FIG. 2 and may be defined in many ways. The facility operation may depend on whether the production facility is a planned production facility or an extant production facility. In a first context, the production facility is a planned production facility and the facility operation (217) includes building the production facility at a planned construction location. In scenarios where the safety protocol (215) includes a minimum distance requirement, performing the facility operation (217) in accordance with the safety protocol (215) includes building the production facility at a distance, from a population or a built structure, of at least the vicinity distance. In a second context, the production facility is an extant production facility and the facility operation includes a maintenance operation of the production facility, an update of the production facility or running the production facility for its intended purpose. Thus, in this second context, performing the facility operation in accordance with the safety protocol may include performing the maintenance operation, the update or running the production facility in compliance with the safety protocol. As a specific example, the maintenance operation may include replacing a part of the production facility and the building specification may include a construction material for that part. In this specific example, performing the facility operation in accordance with the safety protocol may include replacing the part using the specified construction material.

As previously described, the AI models in this disclosure, such as the AI model (209) and the AI model in Step 507 of the method in FIG. 5, may be configured in many ways. Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A notable example of an AI model that may be used as the AI model (209) is a neural network (NN), such as the artificial neural network (303). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

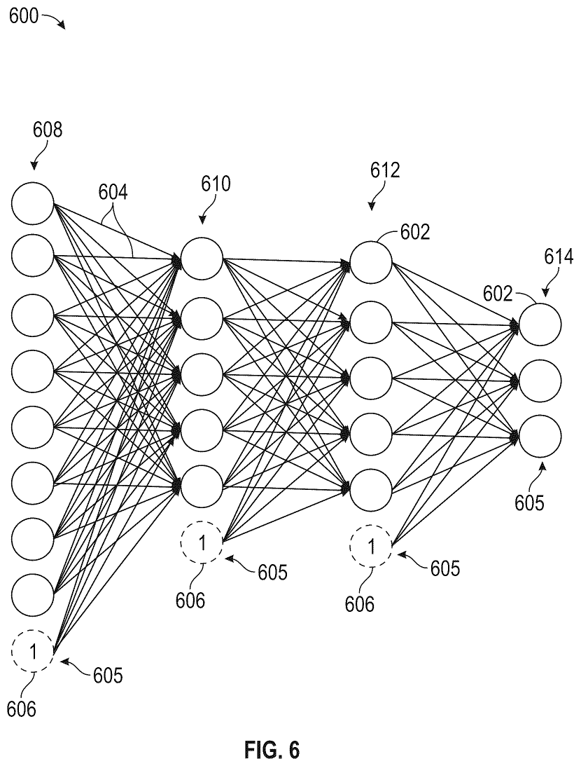

A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer.” A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ . 9$$

where i is an index that spans the set of “incoming” nodes (602) and edges (604) and f is a user-defined function. Incoming nodes (602) are those that, when the neural network (600) is viewed or depicted as a directed graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Training data is provided to the neural network (600). Generally, training data consists of pairs of inputs and associated targets. The targets represent the “ground truth,” or the otherwise desired output, upon processing the inputs. In the context of this disclosure, an example input is a final input of a data sample, including a set of process data or pre-processed process data. An associated output, or target, is a final output of a data sample, including, at least, a rupture exposure radius or pre-processed rupture exposure radius associated with a hazardous material and a concentration level. The concentration level may be defined as a safety limit among the set of one or more safety limits (213). During training, the neural network (600) processes at least one input from the training data and produces at least one output. Each neural network (600) output is compared to its associated input data target. The comparison of the neural network (600) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target. The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target over the training data. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (600), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (600) to produce a final output. Note, that in this context, the neural network (600) is still considered part of the CNN. Like unto a neural network (600), a CNN is trained, after initialization of the filter weights, and the edge (604) values of the internal neural network (600), if present, with the backpropagation process in accordance with a loss function.

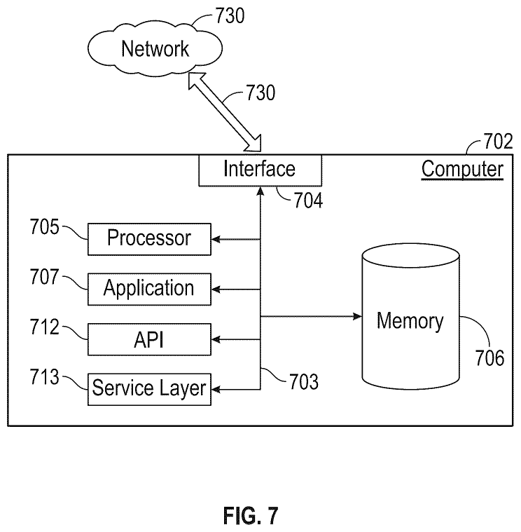

As stated, the computations mentioned in this disclosure may be performed by a computer, such as the computer (413) in FIG. 4. In that regard, FIG. 7 depicts a block diagram of a computer (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. In some implementations, one or more components of the computer (702) may be configured to operate within environments, including cloud-computing-based, local, global, or other environments (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). The memory may be a non-transitory computer readable medium. For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers such as the computer (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers such as the computer (702).

Embodiments of this disclosure provide the following advantages. The system and method described employ advanced AI methods such as SVM and ANN to enhance the accuracy and reliability of RER calculations, crucial for ensuring safety and regulatory compliance. This approach allows for more accurate predictions by adapting to changes in key factors like gas flow rate/AOF, GOR, H2S concentrations, which are critical in determining the spread and concentration of hazardous substances following a rupture. The system considers multiple influencing factors for RER, providing a comprehensive risk assessment tool that is adaptable to different scenarios, including both sour and sweet gas wells, making it versatile for various types of well works including drilling and workover operations. Further, the output of the AI model produces distinct and actionable output radials for different hazard levels, aiding effective safety planning and emergency responses. The methodology is capable of predicting RER as well as it includes outstanding features such as accuracy, robustness while managing data scarcity.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining process data for a production facility configured to convey a production fluid comprising one or more hazardous materials;
obtaining, for each hazardous material among the one or more hazardous materials, one or more safety limits associated with each hazardous material;
determining, using an artificial intelligence (AI) model based on the process data, one or more predicted rupture exposure radii comprising a predicted rupture exposure radius for each hazardous material and associated one or more safety limits;
determining a safety protocol for the production facility based on the one or more predicted rupture exposure radii, and
performing a facility operation associated with the production facility in accordance with the safety protocol.

2. The method of claim 1, wherein the one or more safety limits associated with a hazardous material comprise one or more of:
a flammable concentration level based on a lower flammability limit of the hazardous material, and
a toxicity concentration level based on a toxicity of the hazardous material.

3. The method of claim 1, wherein the AI model comprises one or more of:
a neural network, and
a support vector machine.

4. The method of claim 1, further comprising:
capturing experimental data by conducting a plurality of sample experiments, each sample experiment comprising:
forming a sample production fluid according to a set of sample process data;
releasing the sample production fluid into a controlled environment according to the set of sample process data, and
measuring one or more observed rupture exposure radii associated with the sample production fluid, and
training the AI model using the experimental data.

5. The method of claim 1, wherein:
the production facility comprises one or more of:
a production well, and
a pipeline;
the one or more hazardous materials comprise one or more of:
a flammable hydrocarbon, and
hydrogen sulfide, and
the process data comprise one or more of:
a maximum production fluid flow rate, and
a concentration of a first hazardous material in the production fluid.

6. The method of claim 1, wherein:
the production facility is an extant production facility;
the facility operation comprises a maintenance operation of the extant production facility, and
the process data comprise acquired process data acquired using sensors installed on the extant production facility.

7. The method of claim 1, wherein:
the production facility is a planned production facility;
the facility operation comprises a construction of the planned production facility, and
the process data comprise expected process data.

8. A system, comprising:
a computer comprising one or more computer processors, configured to:
receive process data for a production facility configured to convey a production fluid comprising one or more hazardous materials;
receive, for each hazardous material among the one or more hazardous materials, one or more safety limits associated with each hazardous material, and
determine, using an artificial intelligence (AI) model based on the process data, one or more predicted rupture exposure radii comprising a predicted rupture exposure radius for each hazardous material and associated one or more safety limits;
a safety planning system configured to determine a safety protocol for the production facility based on the one or more predicted rupture exposure radii, and
a service system configured to perform a facility operation associated with the production facility in accordance with the safety protocol.

9. The system of claim 8, wherein the one or more safety limits associated with a hazardous material comprise one or more of:
a flammable concentration level based on a lower flammability limit of the hazardous material, and
a toxicity concentration level based on a toxicity of the hazardous material.

10. The system of claim 8, wherein the AI model comprises one or more of:
a neural network, and
a support vector machine.

11. The system of claim 8, wherein the computer is further configured to:
receive experimental data acquired from a plurality of plurality of sample experiments, each sample experiment comprising:
forming a sample production fluid according to a set of sample process data;
releasing the sample production fluid into a controlled environment according to the set of sample process data, and
measuring one or more observed rupture exposure radii associated with the sample production fluid, and
train the AI model using the experimental data.

12. The system of claim 8, wherein:
the production facility comprises one or more of:
a production well, and
a pipeline;
the one or more hazardous materials comprise one or more of:
a flammable hydrocarbon, and
hydrogen sulfide, and
the process data comprise one or more of:
a maximum production fluid flow rate, and
a concentration of a first hazardous material in the production fluid.

13. The system of claim 8, wherein:
the production facility is an extant production facility;
the facility operation comprises a maintenance operation of the extant production facility;
the process data comprise acquired process data, and
the system further comprises one or more sensors installed on the extant production facility, the one or more sensors configured to acquire the acquired process data.

14. The system of claim 8, wherein:
the production facility is a planned production facility;
the facility operation comprises a construction of the planned production facility, and
the process data comprise expected process data.

15. A non-transitory computer-readable memory comprising computer-executable instructions stored thereon that, when executed on a processor, cause the processor to perform steps comprising:
obtaining process data for a production facility configured to convey a production fluid comprising one or more hazardous materials;
obtaining, for each hazardous material among the one or more hazardous materials, one or more safety limits associated with each hazardous material;
determining, using an artificial intelligence (AI) model based on the process data, one or more predicted rupture exposure radii comprising, a predicted rupture exposure radius for each hazardous material and associated one or more safety limits;
sending a command for a safety planning system to determine a safety protocol for the production facility based on the one or more predicted rupture exposure radii, and
sending a command for a service system to perform a facility operation associated with the production facility in accordance with the safety protocol.

16. The non-transitory computer-readable memory of claim 15, wherein the one or more safety limits associated with a hazardous material comprise one or more of:
a flammable concentration level based on a lower flammability limit of the hazardous material, and
a toxicity concentration level based on a toxicity of the hazardous material.

17. The non-transitory computer-readable memory of claim 15, the steps further comprising:
obtaining experimental data acquired from a plurality of sample experiments, each sample experiment comprising:
forming a sample production fluid according to a set of sample process data;
releasing the sample production fluid into a controlled environment according to the set of sample process data, and
measuring one or more observed rupture exposure radii associated with the sample production fluid, and
training the AI model using the experimental data.

18. The non-transitory computer-readable memory of claim 15, wherein:
the AI model comprises one or more of:
a neural network, and
a support vector machine;
the production facility comprises one or more of:
a hydrocarbon well, and
a pipeline;
the one or more hazardous materials comprise one or more of:
a flammable hydrocarbon, and
hydrogen sulfide, and
the process data comprise one or more of:
a maximum production fluid flow rate, and
a concentration of a first hazardous material in the production fluid.

19. The non-transitory computer-readable memory of claim 15, wherein:
the production facility is an extant production facility;
the process data comprise acquired process data acquired using sensors installed on the extant production facility, and
the facility operation comprises a maintenance operation of the extant production facility.

20. The non-transitory computer-readable memory of claim 15, wherein:
the production facility is a planned production facility;
the process data comprise expected process data, and
the facility operation comprises a construction of the planned production facility.
